(19) United States
(12) Patent Application Publication
(10) Pub. No.: US 2024/0181576 A1
(43) Pub. Date: Jun. 6, 2024

(54) Welding tool

(71) Applicant: Wade Michael Lemons, Canadian, TX (US)

(72) Inventor: Wade Michael Lemons, Canadian, TX (US)

(21) Appl. No.: 18/062,347

(22) Filed: Dec. 6, 2022

(51) Int. Cl. B23K 37/04

(52) U.S. Cl. CPC B23K 37/0426

(57) ABSTRACT

A welding tool for holding two or more welding elements at at an interior joint and an exterior joint. wherein: the welding tool comprises one or more magnets and one or more plates. The one or more plates comprises an an “L” shape having an angle between a first arm and a second arm. The first arm and the second arm is collectively referred to as two arms. The one or more magnets are ferromagnetic. each among the two arms comprises a distal end and a proximate end with each the proximate end joined together at an elbow portion. each among the two arms comprises an arm length, an arm width and an arm thickness. The welding tool comprises the two arms being arranged at a right angle at the angle.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

As discussed below, a first welding element 202a and a second welding element 202b are arranged at a right angle with an exterior joint 300 and an interior joint 302. Further, where said second welding element 202b and a third welding element 202c are substantially parallel and attached to said first welding element 202a at a right angle, a first distance 304 between said second welding element 202b and said third welding element 202c can become a limiting factor.

In some circumstances, said third welding element 202c may necessarily need to be attached to said first welding element 202a prior to said second welding element 202b; wherein, if said first distance 304 is smaller than a prior art width 206 or a prior art height 208, a prior art tool 200 will be unable to fit between said second welding element 202b and said third welding element 202c. This circumstance is illustrated in FIG. 3B.

Examples of such circumstances may include the creation of a gate having multiple bars where the internal bars are easily attached but the outside frame will be too close to a last internal bar. Likewise, handrails, gates, or the like may have such a difficulty.

Similarly, said prior art tool 200 fails in cases where a welder is required to make an enclosed box where said prior art tool 200 cannot physically be inside the final wall of an enclosure without being enclosed by the final weld.

Accordingly, a tool for holding two or more welding elements 202 from said interior joint 302 would be advantageous.

Even when a second worker is present, the job of holding said two or more welding elements 202 at a right angle is very difficult. Said two or more welding elements 202 tend to warp during welding. Likewise, said two or more welding elements 202 can get hot and unmanageable for human hands during welding. Accordingly, a welding tool 100 increases the safety at a worksite, speed of welding and accuracy of workproduct.

Applicant submits drawings of said prior art tool 200. However, no relevant prior art for the contemplated claims of this application is known to the Applicant.

### BRIEF SUMMARY OF THE INVENTION

A welding tool for holding two or more welding elements at at an interior joint and an exterior joint. Wherein: said welding tool comprises one or more magnets and one or more plates. Said one or more plates comprises an an “L” shape having an angle between a first arm and a second arm. Said first arm and said second arm is collectively referred to as two arms. Said one or more magnets are ferromagnetic. Each among said two arms comprises a distal end and a proximate end with each said proximate end joined together at an elbow portion. Each among said two arms comprises an arm length, an arm width and an arm thickness. Said welding tool comprises said two arms being arranged at a right angle at said angle.

Said welding tool for holding said two or more welding elements at at said interior joint and said exterior joint. Wherein: said welding tool comprises said one or more magnets and said one or more plates. Said one or more plates comprises an an “L” shape having said angle between said first arm and said second arm. Said first arm and said second arm is collectively referred to as said two arms. Said one or more magnets are ferromagnetic. Each among said two arms comprises said distal end and said proximate end with each said proximate end joined together at said elbow portion. Each among said two arms comprises said arm length, said arm width and said arm thickness.

Said welding tool for holding said two or more welding elements at at said interior joint and said exterior joint. Wherein: said welding tool comprises said one or more magnets and said one or more plates. Said one or more plates comprises an an “L” shape having said angle between said first arm and said second arm. Said first arm and said second arm is collectively referred to as said two arms. Said one or more magnets are ferromagnetic. Each among said two arms comprises said distal end and said proximate end with each said proximate end joined together at said elbow portion. Each among said two arms comprises said arm length, said arm width and said arm thickness. Said welding tool comprises said two arms being arranged at a right angle at said angle. Each said distal end of said two arms comprises a nonperpendicular face. Said nonperpendicular face comprises a face angle comprising 45 degrees relative to a plane aligned with the respective arm among said two arms. Said nonperpendicular face comprises be longer on an outside face of said distal end than on an interior face of said distal end. Said two or more welding elements is attached to one another at a nonperpendicular angle. Said two or more welding elements comprise at least a first welding element and a second welding element. Said nonperpendicular face of said welding tool is employed to arranged said two or more welding elements prior to welding. Said welding tool is configured for aligning said nonperpendicular face of said two arms with a portion of said second welding element, and providing a stable and ferromagnetic tool for holding said two or more welding elements at said face angle.

### BRIEF DESCRIPTION OF THE SEVERAL VIEWS OF THE DRAWING

FIGS. 1A, 1B and 1C illustrate two perspective overviews and an elevated top view of a welding tool 100.

FIGS. 2A and 2B illustrate a perspective overview and elevated top view of a prior art tool 200 with two or more welding elements 202.

FIGS. 3A and 3B illustrate two perspective overviews of said two or more welding elements 202 with said prior art tool 200.

FIGS. 4A, 4B and 4C illustrate three perspective overviews of said welding tool 100 with said two or more welding elements 202.

FIG. 5 illustrates a perspective overview of said welding tool 100 with said two or more welding elements 202.

FIGS. 6A and 6B illustrate an elevated top and front view of said welding tool 100.

FIGS. 7A and 7B illustrate two perspective overviews of said welding tool 100 with said two or more welding elements 202.

FIGS. 8A and 8B illustrate an elevated side view and perspective overview of said welding tool 100.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

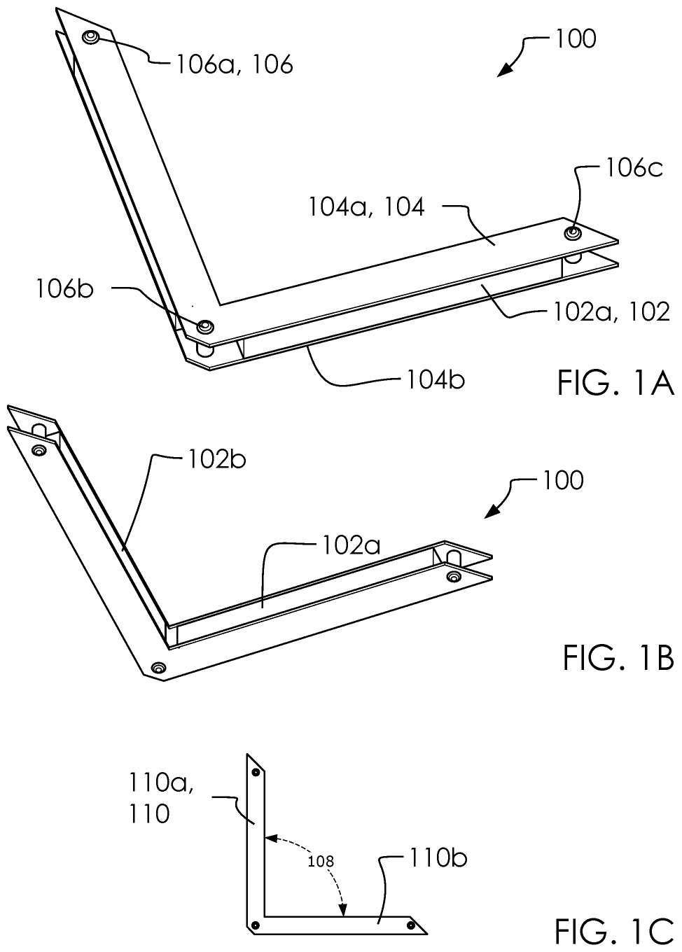

FIGS. 1A, 1B and 1C illustrate two perspective overviews and an elevated top view of a welding tool 100.

In one embodiment, said welding tool 100 can comprise one or more magnets 102, one or more plates 104, and one or more fasteners 106.

In one embodiment, said one or more magnets 102 can comprise can comprise a first magnet 102a and a second magnet 102b. Said one or more plates 104 can comprise a first plate 104a and a second plate 104b. Said one or more fasteners 106 can comprise a first fastener 106a, a second fastener 106b, and a third fastener 106c.

In one embodiment, said one or more fasteners 106 can comprise rivets.

In one embodiment, said one or more plates 104 can comprise an an “L” shape having an angle 108 between a first arm 110a and a second arm 110b. Said angle 108 can comprise a right angle.

Said first arm 110a and said second arm 110b can be collectively referred to as two arms 110.

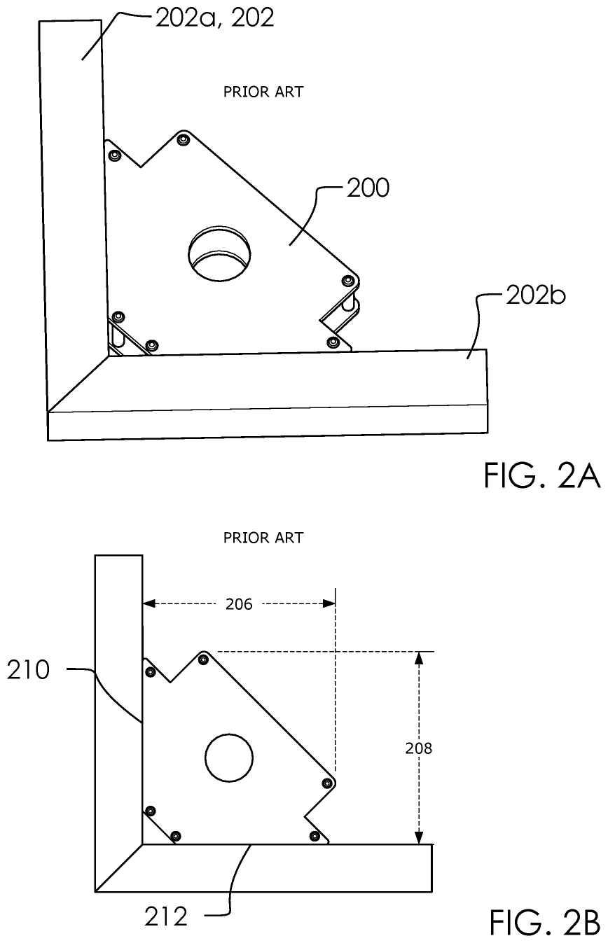

FIGS. 2A and 2B illustrate a perspective overview and elevated top view of a prior art tool 200 with two or more welding elements 202.

Said two or more welding elements 202 can comprise a first welding element 202a, a second welding element 202b, and a third welding element 202c (illustrated below).

Said prior art tool 200 can comprise a prior art width 206 and a prior art height 208.

In one embodiment, said prior art tool 200 can comprise said one or more magnets 102 similar to said welding tool 100 and a shape being substantially arrow shaped with a first edge 210 and a second edge 212 being 90 degrees from one another. In one embodiment, said one or more magnets 102 of said prior art tool 200 can attach to said two or more welding elements 202 and hold them in a substantially 90 degree angle from one another.

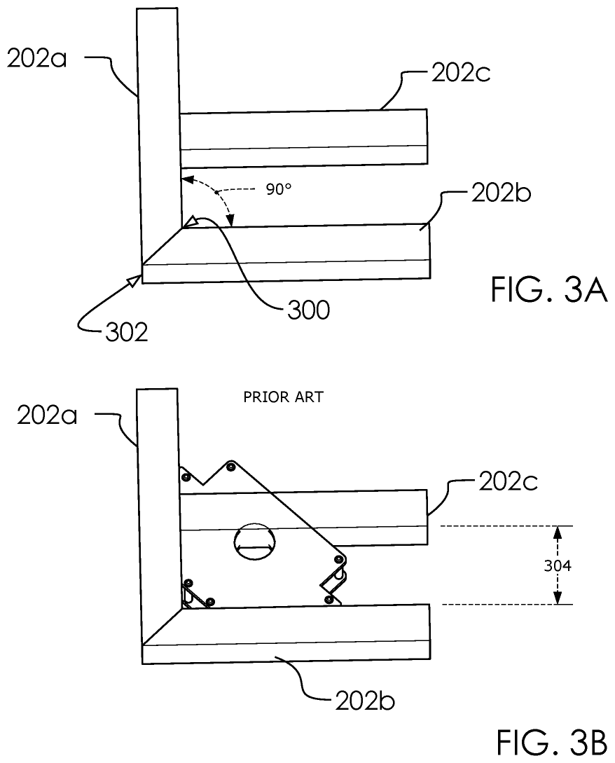

FIGS. 3A and 3B illustrate two perspective overviews of said two or more welding elements 202 with said prior art tool 200.

One failure of said prior art tool 200 is the inability to hold said two or more welding elements 202 at a right angle from an exterior joint 300 of two elements arranged at a right angle.

For example, said first welding element 202a and said second welding element 202b are arranged at a right angle with said exterior joint 300 and an interior joint 302. Further, where said second welding element 202b and said third welding element 202c are substantially parallel and attached to said first welding element 202a at a right angle, a first distance 304 between said second welding element 202b and said third welding element 202c can become a limiting factor.

In some circumstances, said third welding element 202c may necessarily need to be attached to said first welding element 202a prior to said second welding element 202b; wherein, if said first distance 304 is smaller than said prior art width 206 or said prior art height 208, said prior art tool 200 will be unable to fit between said second welding element 202b and said third welding element 202c. This circumstance is illustrated in FIG. 3B.

Examples of such circumstances may include the creation of a gate having multiple bars where the internal bars are easily attached but the outside frame will be too close to a last internal bar. Likewise, handrails, gates, or the like may have such a difficulty.

Similarly, said prior art tool 200 fails in cases where a welder is required to make an enclosed box where said prior art tool 200 cannot physically be inside the final wall of an enclosure without being enclosed by the final weld.

Accordingly, a tool for holding said two or more welding elements 202 from said interior joint 302 would be advantageous.

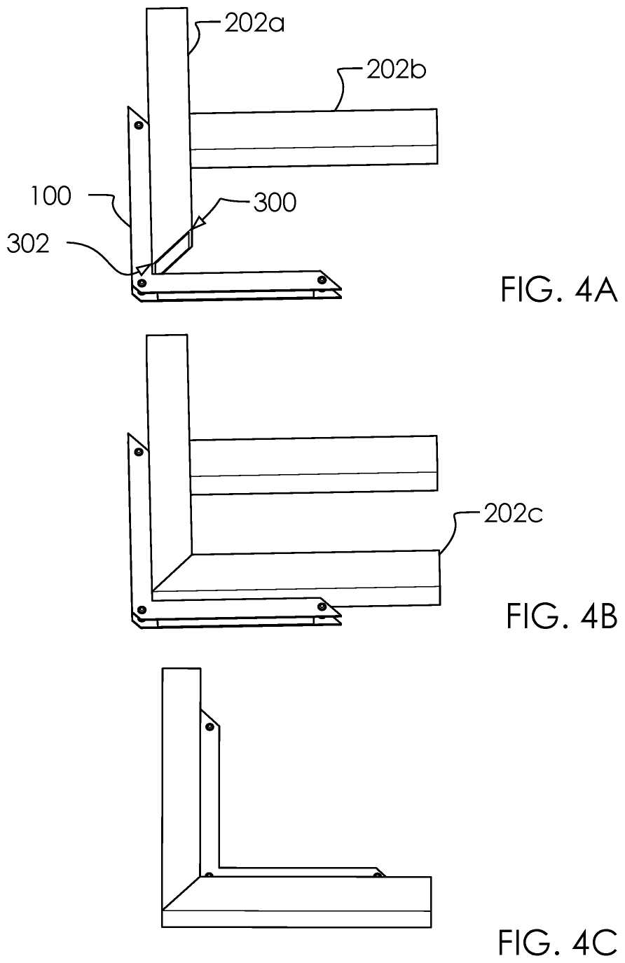

FIGS. 4A, 4B and 4C illustrate three perspective overviews of said welding tool 100 with said two or more welding elements 202.

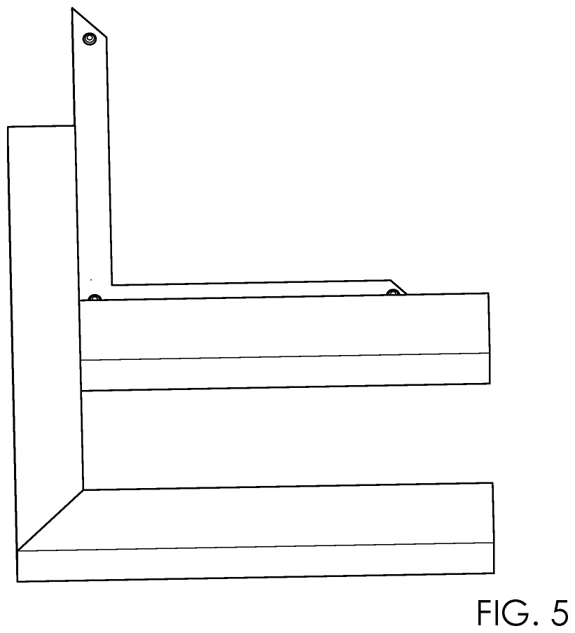

FIG. 5 illustrates a perspective overview of said welding tool 100 with said two or more welding elements 202.

Said welding tool 100 can further be useful when in a field setting. That is, a welder is usually most productive at his shop due to the presence of a welding table and a plurality of clamps which can be used to hold down said two or more welding elements 202 during welding. However, when sent out into a noncontrolled environment such as a worksite, said welding tool 100 can be useful for holding said two or more welding elements 202 in place. In testing, the Applicant has put said welding tool 100 to use to hold together said two or more welding elements 202 as if an extra workman were present to hold said two or more welding elements 202 during welding.

Even when a second worker is present, the job of holding said two or more welding elements 202 at a right angle is very difficult. Said two or more welding elements 202 tend to warp during welding. Likewise, said two or more welding elements 202 can get hot and unmanageable for human hands during welding. Accordingly, said welding tool 100 increases the safety at a worksite, speed of welding and accuracy of workproduct.

As illustrated, said welding tool 100 is suited for holding a portion of said two or more welding elements 202 at said interior joint 302 and said exterior joint 300 for welding.

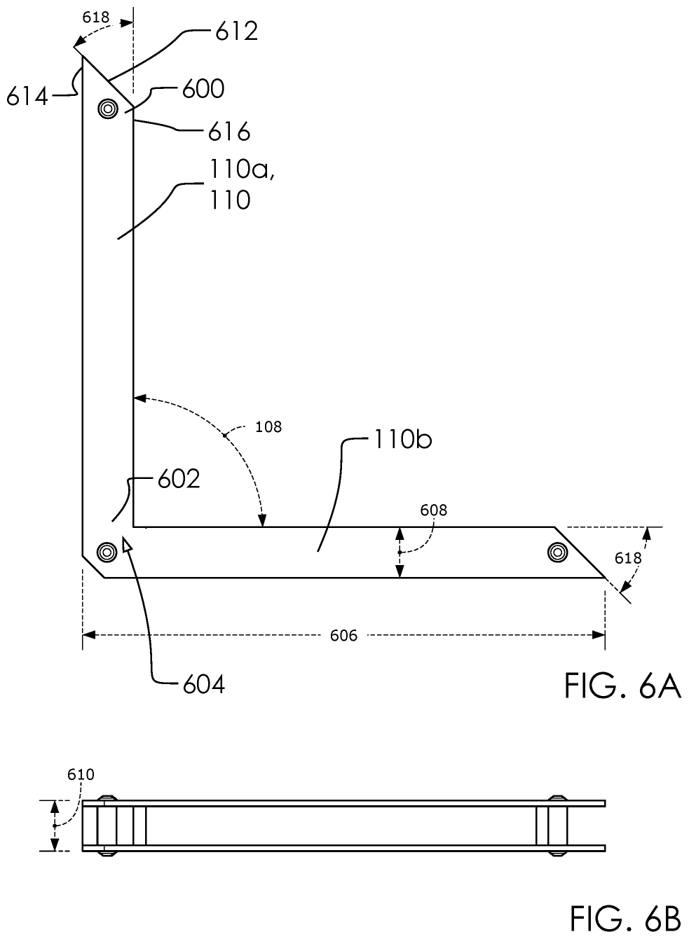

FIGS. 6A and 6B illustrate an elevated top and front view of said welding tool 100.

In one embodiment, said welding tool 100 can comprise said two arms 110 being arranged at a right angle at said angle 108. Each among said two arms 110 can comprise a distal end 600 and a proximate end 602 with each said proximate end 602 joined together at an elbow portion 604.

Each among said two arms 110 can comprise an arm length 606, an arm width 608 and an arm thickness 610.

In one embodiment, each said distal end 600 of said two arms 110 can comprise a nonperpendicular face 612. In one embodiment, said nonperpendicular face 612 can comprise a face angle 618 comprising 45 degrees relative to a plane aligned with the respective arm among said two arms 110. Wherein, said nonperpendicular face 612 can comprise be longer on an outside face 614 of said distal end 600 than on an interior face 616 of said distal end 600.

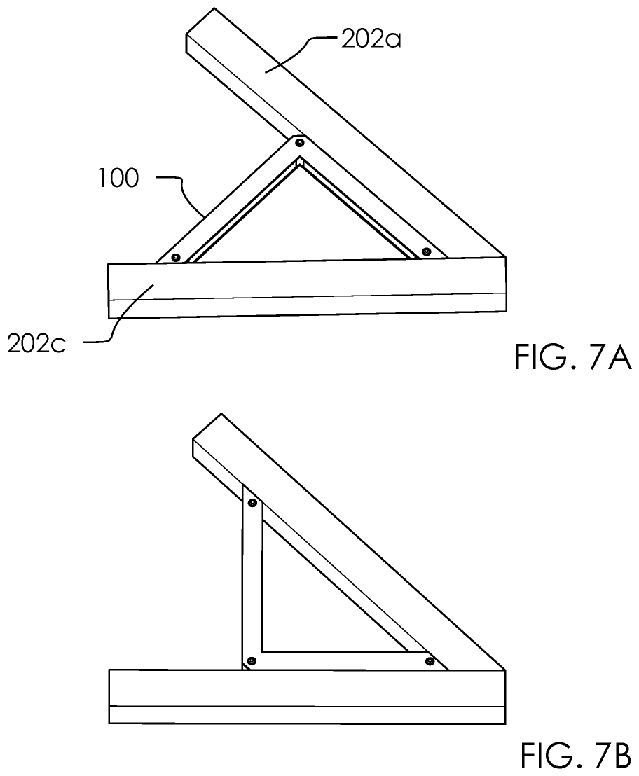

FIGS. 7A and 7B illustrate two perspective overviews of said welding tool 100 with said two or more welding elements 202.

In one embodiment, said two or more welding elements 202 can be attached to one another at a nonperpendicular angle. In one embodiment, said nonperpendicular face 612 of said welding tool 100 can be employed to arranged said two or more welding elements 202 prior to welding.

For example, in one case, said first welding element 202a and said third welding element 202c may be attached to one another at a 45 degree angle. In such a case said face angle 618 can comprise 45 degrees. By aligning said nonperpendicular face 612 of said two arms 110 with a portion of said third welding element 202c, said welding tool 100 can create a stable and ferromagnetic tool for holding said two or more welding elements 202 at said face angle 618, as illustrated.

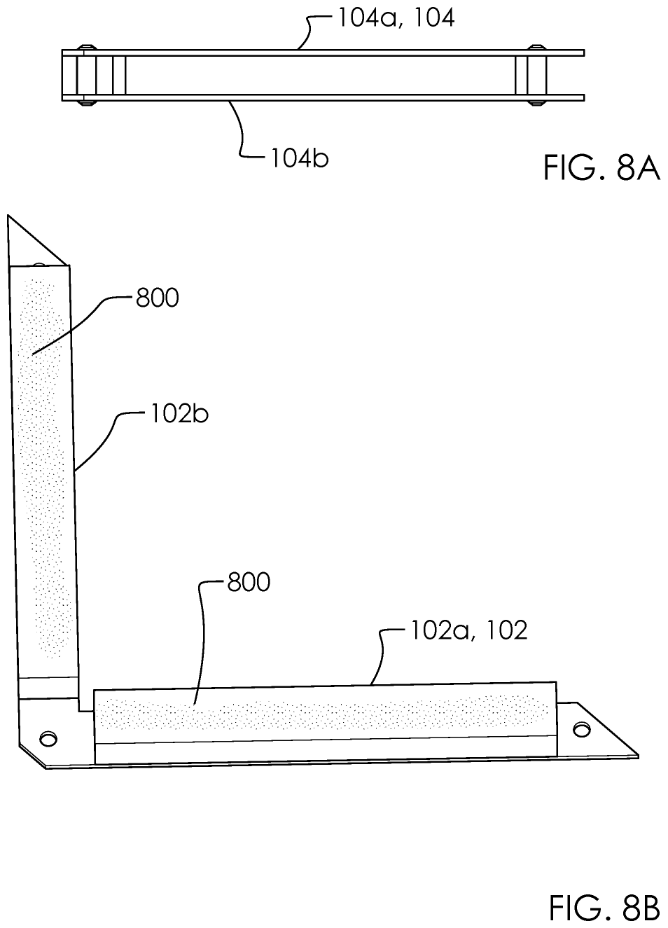

FIGS. 8A and 8B illustrate an elevated side view and perspective overview of said welding tool 100.

In one embodiment, said one or more magnets 102 and said one or more plates 104 can be attached to one another using said one or more fasteners 106 and an adhesive 800. In one embodiment, said adhesive 800 can be applied between portions of said one or more plates 104 and said one or more magnets 102, such as below said first plate 104a and above said second plate 104b and in touch with a portion of said one or more magnets 102.

In one embodiment, portions of said welding tool 100, such as said one or more plates 104 can be powder-coated for protection of said welding tool 100.

In one embodiment, said one or more magnets 102 can be ferromagnetic; and said welding tool 100 can comprise steel or other durable materials such as metals.

The parts list follows.
Said welding tool 100,
Said one or more magnets 102,
Said one or more plates 104,
Said one or more fasteners 106,
Said first magnet 102a,
Said second magnet 102b,
Said first plate 104a,
Said second plate 104b,
Said first fastener 106a,
Said second fastener 106b,
Said third fastener 106c,
Said angle 108,
Said first arm 110a,
Said second arm 110b,
Said two arms 110,
Said prior art tool 200,
Said two or more welding elements 202,
Said first welding element 202a,
Said second welding element 202b,
Said third welding element 202c,
Said prior art width 206,
Said prior art height 208,
Said first edge 210,
Said second edge 212,
Said exterior joint 300,
Said interior joint 302,
Said first distance 304,
Said distal end 600,
Said proximate end 602,
Said elbow portion 604,
Said arm length 606,
Said arm width 608,
Said arm thickness 610,
Said nonperpendicular face 612,
Said face angle 618,
Said outside face 614,
Said interior face 616, and
said adhesive 800.

Preferred embodiment with reference to the original claims:
said welding tool 100 for holding said two or more welding elements 202 at at said interior joint 302 and said exterior joint 300. Wherein: said welding tool 100 comprises said one or more magnets 102 and said one or more plates 104. Said one or more plates 104 comprises an an “L” shape having said angle 108 between said first arm 110a and said second arm 110b. Said first arm 110a and said second arm 110b can be collectively referred to as said two arms 110. Said one or more magnets 102 can be ferromagnetic. Each among said two arms 110 comprises said distal end 600 and said proximate end 602 with each said proximate end 602 joined together at said elbow portion 604. Each among said two arms 110 comprises said arm length 606, said arm width 608 and said arm thickness 610. Said welding tool 100 comprises said two arms 110 being arranged at a right angle at said angle 108.

Said welding tool 100 for holding said two or more welding elements 202 at at said interior joint 302 and said exterior joint 300. Wherein: said welding tool 100 comprises said one or more magnets 102 and said one or more plates 104. Said one or more plates 104 comprises an an “L” shape having said angle 108 between said first arm 110a and said second arm 110b. Said first arm 110a and said second arm 110b can be collectively referred to as said two arms 110. Said one or more magnets 102 can be ferromagnetic. Each among said two arms 110 comprises said distal end 600 and said proximate end 602 with each said proximate end 602 joined together at said elbow portion 604. Each among said two arms 110 comprises said arm length 606, said arm width 608 and said arm thickness 610. Said welding tool 100 comprises said two arms 110 being arranged at a right angle at said angle 108.

Said welding tool 100 for holding said two or more welding elements 202 at at said interior joint 302 and said exterior joint 300. Wherein: said welding tool 100 comprises said one or more magnets 102 and said one or more plates 104. Said one or more plates 104 comprises an an “L” shape having said angle 108 between said first arm 110a and said second arm 110b. Said first arm 110a and said second arm 110b can be collectively referred to as said two arms 110. Said one or more magnets 102 can be ferromagnetic. Each among said two arms 110 comprises said distal end 600 and said proximate end 602 with each said proximate end 602 joined together at said elbow portion 604. Each among said two arms 110 comprises said arm length 606, said arm width 608 and said arm thickness 610.

Said welding tool 100 comprises said two arms 110 being arranged at a right angle at said angle 108.

Each said distal end 600 of said two arms 110 comprises said nonperpendicular face 612. Said nonperpendicular face 612 comprises said face angle 618 comprising 45 degrees relative to a plane aligned with the respective arm among said two arms 110. Said nonperpendicular face 612 comprises be longer on said outside face 614 of said distal end 600 than on said interior face 616 of said distal end 600. Said two or more welding elements 202 can be attached to one another at a nonperpendicular angle. Said two or more welding elements 202 comprise at least said first welding element 202a and said second welding element 202b. Said nonperpendicular face 612 of said welding tool 100 can be employed to arranged said two or more welding elements 202 prior to welding. Said welding tool 100 can be configured for aligning said nonperpendicular face 612 of said two arms 110 with a portion of said second welding element 202b, providing a stable and ferromagnetic tool for holding said two or more welding elements 202 at said face angle 618.

Portions of said welding tool 100, such as said one or more plates 104 can be powder-coated for protection of said welding tool 100.

Said welding tool 100 comprises steel or other durable materials such as metals.

Said welding tool 100 further comprises said one or more fasteners 106. Said one or more fasteners 106 comprises said first fastener 106a, said second fastener 106b, and said third fastener 106c. Said one or more magnets 102 and said one or more plates 104 can be attached to one another using said one or more fasteners 106.

Said one or more magnets 102 and said one or more plates 104 can be attached to one another using said adhesive 800. Said one or more plates 104 comprises said first plate 104a and said second plate 104b. Said adhesive 800 can be applied between portions of said one or more plates 104 and said one or more magnets 102, such as below said first plate 104a and above said second plate 104b and in touch with a portion of said one or more magnets 102.

Said welding tool 100 for holding said two or more welding elements 202 at at said interior joint 302 and said exterior joint 300. Wherein: said welding tool 100 comprises said one or more magnets 102 and said one or more plates 104. Said one or more plates 104 comprises an an “L” shape having said angle 108 between said first arm 110a and said second arm 110b. Said first arm 110a and said second arm 110b can be collectively referred to as said two arms 110. Said one or more magnets 102 can be ferromagnetic. Each among said two arms 110 comprises said distal end 600 and said proximate end 602 with each said proximate end 602 joined together at said elbow portion 604. Each among said two arms 110 comprises said arm length 606, said arm width 608 and said arm thickness 610. Said welding tool 100 comprises said two arms 110 being arranged at a right angle at said angle 108. Each said distal end 600 of said two arms 110 comprises said nonperpendicular face 612. Said nonperpendicular face 612 comprises said face angle 618 comprising 45 degrees relative to a plane aligned with the respective arm among said two arms 110. Said nonperpendicular face 612 comprises be longer on said outside face 614 of said distal end 600 than on said interior face 616 of said distal end 600. Said two or more welding elements 202 can be attached to one another at a nonperpendicular angle. Said two or more welding elements 202 comprise at least said first welding element 202a and said second welding element 202b. Said nonperpendicular face 612 of said welding tool 100 can be employed to arranged said two or more welding elements 202 prior to welding. Said welding tool 100 can be configured for aligning said nonperpendicular face 612 of said two arms 110 with a portion of said second welding element 202b, and providing a stable and ferromagnetic tool for holding said two or more welding elements 202 at said face angle 618.

Portions of said welding tool 100, such as said one or more plates 104 can be powder-coated for protection of said welding tool 100.

Said welding tool 100 comprises steel or other durable materials such as metals.

Said welding tool 100 further comprises said one or more fasteners 106. Said one or more fasteners 106 comprises said first fastener 106a, said second fastener 106b, and said third fastener 106c. Said one or more magnets 102 and said one or more plates 104 can be attached to one another using said one or more fasteners 106.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A welding tool for holding two or more welding elements at at an interior joint and an exterior joint; wherein:
said welding tool comprises one or more magnets and one or more plates;
said one or more plates comprises an an “L” shape having an angle between a first arm and a second arm;
said first arm and said second arm is collectively referred to as two arms;
said one or more magnets are ferromagnetic;
each among said two arms comprises a distal end and a proximate end with each said proximate end joined together at an elbow portion;
each among said two arms comprises an arm length, an arm width and an arm thickness; and
said welding tool comprises said two arms being arranged at a right angle at said angle.

2. A welding tool for holding two or more welding elements at at an interior joint and an exterior joint; wherein:
said welding tool comprises one or more magnets and one or more plates;
said one or more plates comprises an an “L” shape having an angle between a first arm and a second arm;
said first arm and said second arm is collectively referred to as two arms;
said one or more magnets are ferromagnetic;
each among said two arms comprises a distal end and a proximate end with each said proximate end joined together at an elbow portion; and
each among said two arms comprises an arm length, an arm width and an arm thickness.

3. The welding tool of claim 2, wherein:
said welding tool comprises said two arms being arranged at a right angle at said angle.

4. The welding tool of claim 2, wherein:
each said distal end of said two arms comprises a nonperpendicular face;
said nonperpendicular face comprises a face angle comprising 45 degrees relative to a plane aligned with the respective arm among said two arms;
said nonperpendicular face comprises be longer on an outside face of said distal end than on an interior face of said distal end;
said two or more welding elements is attached to one another at a nonperpendicular angle;
said two or more welding elements comprise at least a first welding element and a second welding element;
said nonperpendicular face of said welding tool is employed to arranged said two or more welding elements prior to welding; and
said welding tool is configured for
aligning said nonperpendicular face of said two arms with a portion of said second welding element,
providing a stable and ferromagnetic tool for holding said two or more welding elements at said face angle.

5. The welding tool of claim 2, wherein:
portions of said welding tool, such as said one or more plates are powder-coated for protection of said welding tool.

6. The welding tool of claim 2, wherein:
said welding tool comprises steel.

7. The welding tool of claim 2, wherein:
said welding tool further comprises one or more fasteners;
said one or more fasteners comprises a first fastener, a second fastener, and a third fastener; and
said one or more magnets and said one or more plates are attached to one another using said one or more fasteners.

8. The welding tool of claim 2, wherein:
said one or more magnets and said one or more plates are attached to one another using an adhesive;
said one or more plates comprises a first plate and a second plate; and
said adhesive is applied between portions of said one or more plates and said one or more magnets, such as below said first plate and above said second plate and in touch with a portion of said one or more magnets.

9. A welding tool for holding two or more welding elements at at an interior joint and an exterior joint; wherein:
said welding tool comprises one or more magnets and one or more plates;
said one or more plates comprises an an “L” shape having an angle between a first arm and a second arm;
said first arm and said second arm is collectively referred to as two arms;
said one or more magnets are ferromagnetic;
each among said two arms comprises a distal end and a proximate end with each said proximate end joined together at an elbow portion;
each among said two arms comprises an arm length, an arm width and an arm thickness;
said welding tool comprises said two arms being arranged at a right angle at said angle;
each said distal end of said two arms comprises a nonperpendicular face;
said nonperpendicular face comprises a face angle comprising 45 degrees relative to a plane aligned with the respective arm among said two arms;
said nonperpendicular face comprises be longer on an outside face of said distal end than on an interior face of said distal end;
said two or more welding elements is attached to one another at a nonperpendicular angle;
said two or more welding elements comprise at least a first welding element and a second welding element;
said nonperpendicular face of said welding tool is employed to arranged said two or more welding elements prior to welding; and
said welding tool is configured for
aligning said nonperpendicular face of said two arms with a portion of said second welding element, and
providing a stable and ferromagnetic tool for holding said two or more welding elements at said face angle.

10. The welding tool of claim 9, wherein:
portions of said welding tool, such as said one or more plates are powder-coated for protection of said welding tool.

11. The welding tool of claim 9, wherein:
said welding tool comprises steel.

12. The welding tool of claim 9, wherein:
said welding tool further comprises one or more fasteners;
said one or more fasteners comprises a first fastener, a second fastener, and a third fastener; and
said one or more magnets and said one or more plates are attached to one another using said one or more fasteners.

13. The welding tool of claim 9, wherein:
said one or more magnets and said one or more plates are attached to one another using an adhesive;
said one or more plates comprises a first plate and a second plate; and
said adhesive is applied between portions of said one or more plates and said one or more magnets, such as below said first plate and above said second plate and in touch with a portion of said one or more magnets.
